(19) United States
(12) Patent Application Publication
(10) Pub. No.: US 2012/0249872 A1
(43) Pub. Date: Oct. 4, 2012

(54) VIDEO SIGNAL PROCESSING APPARATUS AND VIDEO SIGNAL PROCESSING METHOD

(75) Inventor: Makoto Nakagawa, Tokyo (JP)

(73) Assignee: SONY CORPORATION, Tokyo (JP)

(21) Appl. No.: 13/417,737

(22) Filed: Mar. 12, 2012

(30) Foreign Application Priority Data
Mar. 28, 2011 (JP) 2011-070940

(51) Int. Cl. H04N 9/74; H04N 7/01

(52) U.S. Cl. 348/441; 348/E09.055

(57) ABSTRACT

A video signal processing apparatus includes a video input unit configured to input a video signal for which resolution is reduced in at least a part of a display area, an image data changing unit configured to change, in response to the resolution, image data to be superimposed on an area in which the resolution is reduced, and a video superimposing unit configured to superimpose the image data changed by the image data changing unit on the video signal input by the video input unit.

### CROSS-REFERENCE TO RELATED APPLICATION

The present application claims priority from Japanese Patent Application No. JP 2011-070940, filed in the Japanese Patent Office on Mar. 28, 2011, the entire content of which is incorporated herein by reference.

### BACKGROUND

The present disclosure relates to a video signal processing apparatus and a video signal processing method used to process a video signal to be displayed and output on a display device that has a mode in which resolution is reduced in at least a part of a display area. For example, the present disclosure relates to a video signal processing apparatus and a video signal processing method used to process a video signal such as a stereoscopic image in which a right-eye image and a left-eye image are displayed alternately for each pixel line or a multi-viewpoint image in which a plurality of parallax images are multiplexed.

A stereoscopic image that appears to a viewer as three-dimensional can be provided by displaying images having parallax to the right and left eyes of the viewer. The stereoscopic imaging technology is expected to be applied in various fields, such as television broadcasting, movies, telecommunication, and telemedicine.

Basically, an image that can be viewed stereoscopically is a photographed two-viewpoint image including a left-eye image and a right-eye image obtained by photographing an object with a left-eye camera and a right-eye camera. In contrast, when the number of viewpoints is increased to four, eight, or more, and parallax images taken from more directions are synthesized, it becomes possible to view a natural stereoscopic video image not only from the front but also from a wider viewpoint.

On the other hand, in a display device on which a multi-viewpoint image is displayed by allocating screen pixels to each viewpoint and multiplexing and simultaneously displaying parallax images for individual viewpoints, it has been found that resolution decreases as the number of viewpoints increases. Therefore, when a thin line with a width of about one pixel (or with a resolution smaller than or equal to that of a parallax image) is drawn, the line may be seen from one viewpoint but may not be seen from another viewpoint, possibly causing a reduction in the visibility. For example, binocular rivalry occurs if a line is displayed to one of the right and left eyes but is not displayed to the other.

For example, in a stereoscopic display system in which a right-eye image and a left-eye image are displayed alternately for each pixel line and switching of polarization states of the right-eye image and the left-eye image is performed with a polarization control filter, a viewer can obtain a stereoscopic view of an image displayed on a screen by wearing glasses in which the polarization states are changed on the right and left so that the right-eye image and the left-eye image can be seen from the right eye and the left eye, respectively (for example, refer to Japanese Unexamined Patent Application Publications No. 2010-204389 and No. 2010-250257).

On a stereoscopic display device with the above polarization system, because a right-eye image and a left-eye image are displayed and output alternately for each line, the resolution in the vertical direction of the screen is reduced to one half when a stereoscopic image is displayed, as compared to when an ordinary 2D image is displayed. Therefore, when a thin horizontal line with a width of one pixel is displayed, the line is displayed to one eye but is not displayed to the other, and binocular rivalry occurs.

Another display device is proposed in which switching between a 2D display and a 3D display can be performed with, for example, a liquid crystal panel of which the refractive index changes in response to applied voltage (for example, refer to Japanese Unexamined Patent Application Publication No. 2003-185991). In this type of display device, in a display area with the display switched to 3D, resolution decreases significantly as the number of viewpoints increases, causing a reduction in the visibility of small lines.

Still another display device is being widely used in which glasses-free 3D is realized by disposing an optical element such as a lenticular lens or parallax barrier so as to face a display screen in order to control pixels that can be seen from a specific position (for example, refer to U.S. Pat. No. 6,064,424). In this type of multi-viewpoint image display device, the resolution in the vertical and horizontal directions of the screen is reduced, causing a reduction in the visibility of small vertical and horizontal lines.

In a natural image taken with a camera, a thin line with a width of one pixel is rarely drawn. On the other hand, in an artificial image such as an on-screen display (OSD), a small character or graphics are often drawn, and therefore binocular rivalry tends to occur when a stereoscopic image or multi-viewpoint image is displayed.

### SUMMARY

It is desirable to provide a superior video signal processing apparatus and video signal processing method operable to suitably process a video signal to be displayed and output on a display device that has a mode in which resolution is reduced in at least a part of a display area; such a video signal may be a stereoscopic image in which a right-eye image and a left-eye image are displayed alternately for each pixel line or a multi-viewpoint image in which a plurality of parallax images are multiplexed.

Further, it is desirable to provide a superior video signal processing apparatus and video signal processing method operable to suitably display a thin line with a width of about one pixel in a display area with reduced resolution while preventing binocular rivalry from occurring.

A video signal processing apparatus according to an embodiment of the present disclosure includes a video input unit configured to input a video signal for which resolution is reduced in at least a part of a display area, an image data changing unit configured to change, in response to the resolution, image data to be superimposed on an area in which the resolution is reduced, and a video superimposing unit configured to superimpose the image data changed by the image data changing unit on the video signal input by the video input unit.

According to another embodiment of the present disclosure, the image data changing unit of the video signal processing apparatus of the embodiment described above is configured to resize image data so that a horizontal line has a width of n_V pixels or more and a vertical line has a width of n_H pixels or more when the resolution is reduced to 1/n_V and 1/n_H in the vertical and horizontal directions of a screen, respectively.

A video signal processing method according to still another embodiment of the present disclosure includes inputting a video signal for which resolution is reduced in at least a part of a display area, changing, in response to the resolution, image data to be superimposed on an area in which the resolution is reduced, and superimposing the changed image data on the input video signal.

According to the embodiments of the present disclosure, it is possible to provide a superior video signal processing apparatus and video signal processing method operable to suitably process a video signal to be displayed and output on a display device that has a mode in which resolution is reduced in at least a part of a display area; such a video signal may be a stereoscopic image in which a right-eye image and a left-eye image are displayed alternately for each pixel line or a multi-viewpoint image in which a plurality of parallax images are multiplexed.

Further, according to the embodiments of the present disclosure, it is possible to provide a superior video signal processing apparatus and video signal processing method operable to suitably display a thin line with a width of about one pixel in a display area with reduced resolution while preventing binocular rivalry from occurring.

Other purposes, features, and advantageous effects of the embodiments of the present disclosure will be shown in a later-described embodiment and a detailed description based on the accompanying drawings.

### BRIEF DESCRIPTION OF THE DRAWINGS

FIG. 1A illustrates a visible image when a font including thin lines is displayed in a mode in which resolution is reduced (ordinary font);

FIG. 1B illustrates a visible image when a font including thin lines is displayed in a mode in which resolution is reduced (left-eye image);

FIG. 1C illustrates a visible image when a font including thin lines is displayed in a mode in which resolution is reduced (right-eye image);

FIG. 1D illustrates a visible image when a font including thin lines is displayed in a mode in which resolution is reduced (visible image);

FIG. 2A illustrates a visible image when a font including thin lines is enlarged and displayed in a mode in which resolution is reduced (font for a stereoscopic image);

FIG. 2B illustrates a visible image when a font including thin lines is enlarged and displayed in a mode in which resolution is reduced (left-eye image);

FIG. 2C illustrates a visible image when a font including thin lines is enlarged and displayed in a mode in which resolution is reduced (right-eye image);

FIG. 2D illustrates a visible image when a font including thin lines is enlarged and displayed in a mode in which resolution is reduced (visible image);

FIG. 3 shows an example of the configuration of a video signal processing apparatus used to process a video signal to be displayed and output on a display device that has a mode in which resolution is reduced in at least a part of a display area; and

FIG. 4 shows another example of the configuration of a video signal processing apparatus.

### DETAILED DESCRIPTION OF EMBODIMENTS

Embodiments of the present disclosure are described below in detail in reference to the accompanying drawings.

As described above, on a display device that has a mode in which resolution is reduced in at least a part of a display area, there is a problem of poor visibility when a thin line with a width of about one pixel is displayed in an area with reduced resolution.

For example, in a stereoscopic display system with a polarization control filter, because a right-eye image and a left-eye image are displayed alternately for each pixel line, the resolution in the vertical direction of the screen is reduced to one half. Therefore, when a thin horizontal line with a width of one pixel is displayed, the line is displayed to one eye but is not displayed to the other, and binocular rivalry occurs.

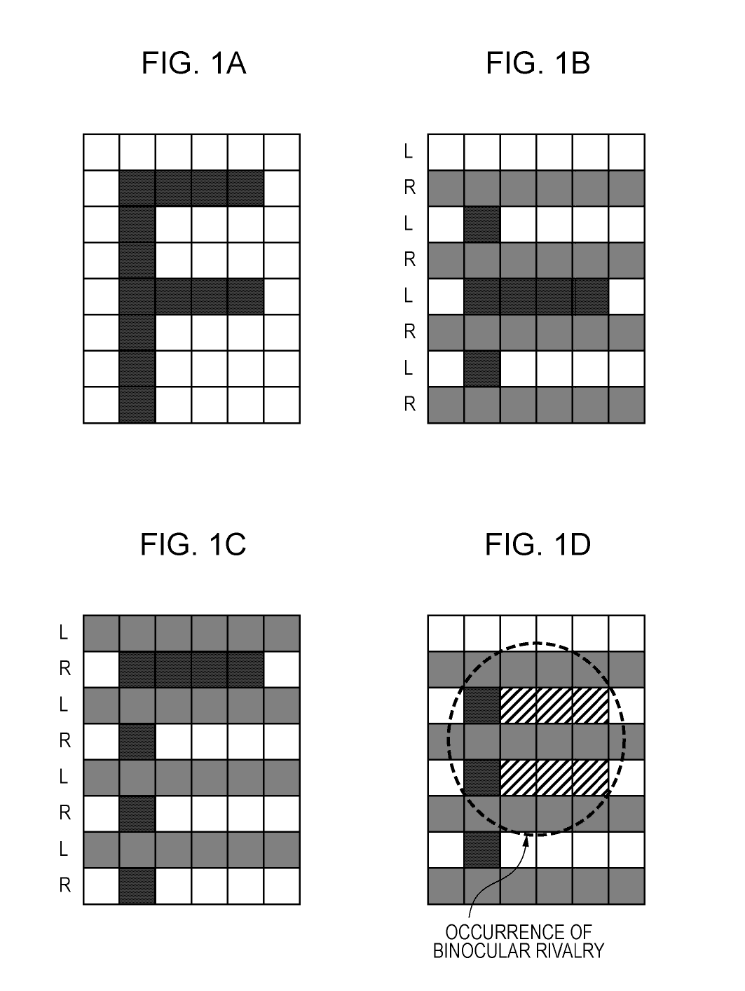

For example, consider a stereoscopic display of the letter “F” in a font with a width of only one pixel both vertically and horizontally, shown in FIG. 1A. When a left-eye image and a right-eye image are displayed alternately for each pixel line, the letter in the font shown in FIG. 1A is displayed to the left eye and the right eye as the left-eye image and the right-eye image, as shown in FIG. 1B and FIG. 1C, respectively. As can be noted from FIG. 1B and FIG. 1C, a horizontal line with a width of only one pixel in the letter “F” in the font is displayed only in either the left-eye image or the right-eye image. When a viewer sees the image shown in FIG. 1B with the left eye and the image shown in FIG. 1C with the right eye, the fusion of these images is performed in the viewer's head, and a visible image as shown in FIG. 1D is obtained. Then, binocular rivalry occurs in a portion enclosed by a broken line in FIG. 1D.

The inventor and others thus propose a method for switching an original font to a low-resolution font in order to prevent binocular rivalry when a thin line is displayed in a display area with reduced resolution.

For the low-resolution font used when the resolution is reduced, for example, to 1/n_V and 1/n_H in the vertical and horizontal directions of a screen, respectively, the original font includes a horizontal line with a width of n_V pixels or more and a vertical line with a width of n_H pixels or more.

These low-resolution font images may be stored in advance together with original fonts. When a font is superimposed on a display area with reduced resolution, a font image to be used may be switched in response to the resolution in the display area.

Alternatively, when a font is superimposed on a display area with reduced resolution, the original font image may be resized (that is, the image may be dynamically generated) in response to the resolution in the display area.

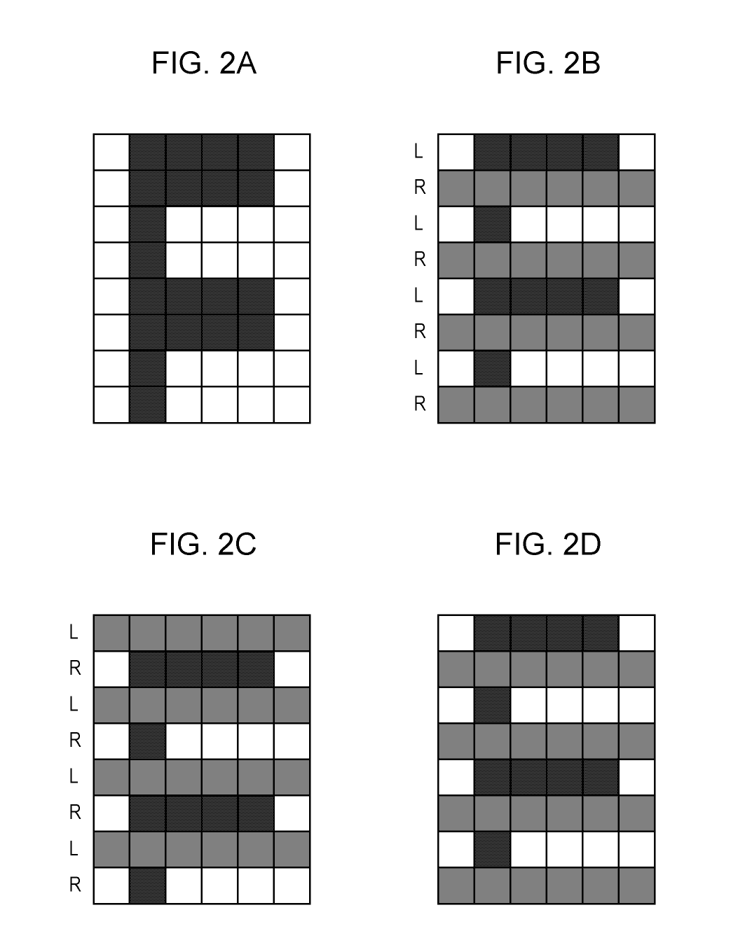

FIG. 2A shows a low-resolution font image obtained by replacing (or resizing) the letter “F” in a font with a width of only one pixel both vertically and horizontally, shown in FIG. 1A, to use the font in a display area in which a right-eye image and a left-eye image are displayed alternately for each pixel line (that is, the display area in which the resolution in the vertical direction of the screen is reduced to one half). The resolution in the vertical direction of the screen is reduced to one half, and therefore the horizontal width is resized to have two pixels (or more) as shown in FIG. 2A because the width of a horizontal line of the letter “F” in the original font is only one pixel as shown in FIG. 1A.

The font shown in FIG. 2A is displayed to the left eye and the right eye as a left-eye image and a right-eye image, as shown in FIG. 2B and FIG. 2C, respectively. Unlike FIG. 1B and FIG. 1C, the width of a horizontal line of the letter “F” in the font is broadened to two pixels or more, and therefore horizontal lines of the letter “F” in the font are displayed both in the left-eye image and the right-eye image. The fusion of these images is performed in the viewer's head, and a visible image as shown in FIG. 2D is obtained. Binocular rivalry does not occur because horizontal lines are displayed both in the left-eye image and the right-eye image.

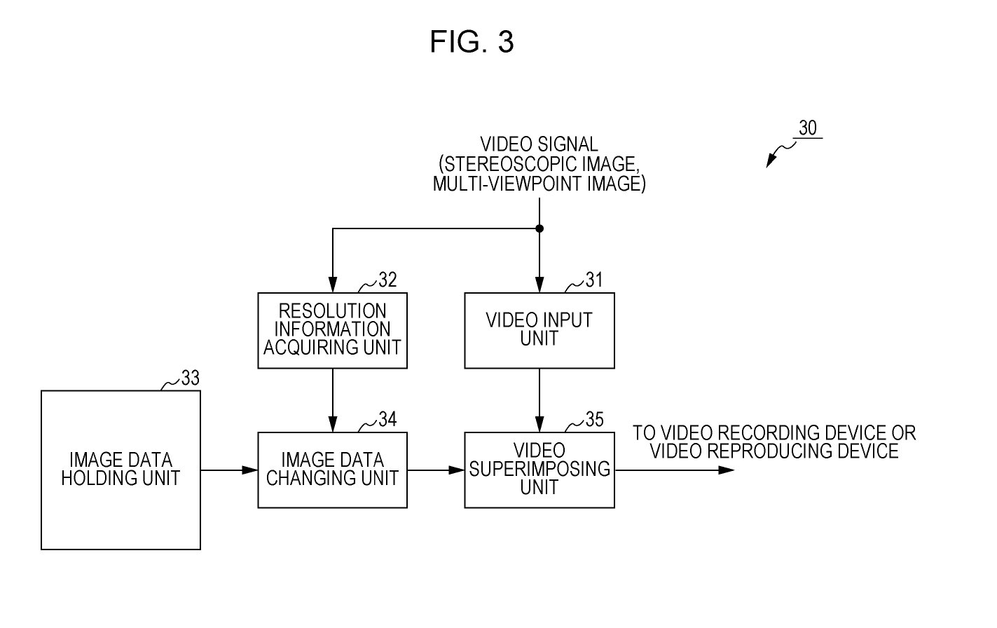

FIG. 3 shows an example of the configuration of a video signal processing apparatus 30 used to process a video signal to be displayed and output on a display device that has a mode in which resolution is reduced in at least a part of a display area. Video signal processing performed by the video signal processing apparatus 30 shown in FIG. 3 can be applied both when a stereoscopic image is recorded and when the recorded stereoscopic image is reproduced.

A video input unit 31 inputs a video signal from an external source. Input video signals may include a video signal for which resolution is reduced in at least a part of a display area, such as a stereoscopic image or a multi-viewpoint image. The “external source” of video signal transmission mentioned here may be a content reproducing device such as a receiver for digital broadcasting or a blu-ray disc player.

When a video signal input by the video input unit 31 includes a display area in which resolution is reduced, a resolution information acquiring unit 32 acquires reduced resolution levels 1/n_V and 1/n_H in the vertical and horizontal directions of the display area, together with positional information of the area. A specific acquisition method is not limited to a particular one. The resolution may be determined on the basis of a signal from a video signal source or a video signal format. Alternatively, a user may control and input the resolution.

An image data holding unit 33 holds image data, such as character fonts or graphics, to be superimposed on a video signal.

An image data changing unit 34 retrieves, from the image data holding unit 33, image data to be superimposed on the video signal input by the video input unit 31, and determines, on the basis of information sent from the resolution information acquiring unit 32, whether a position of superimposition of the image data is within a display area in which resolution is reduced. The image data changing unit 34 then resizes the image data to be superimposed on a display area in which the resolution is reduced so that a horizontal line has a width of n_V pixels or more and a vertical line has a width of n_H pixels or more.

Then, a video superimposing unit 35 superimposes the image data changed by the image data changing unit 34 on the video signal input by the video input unit 31, and outputs the video signal to a video recording device or video reproducing device (both not shown) in a subsequent stage.

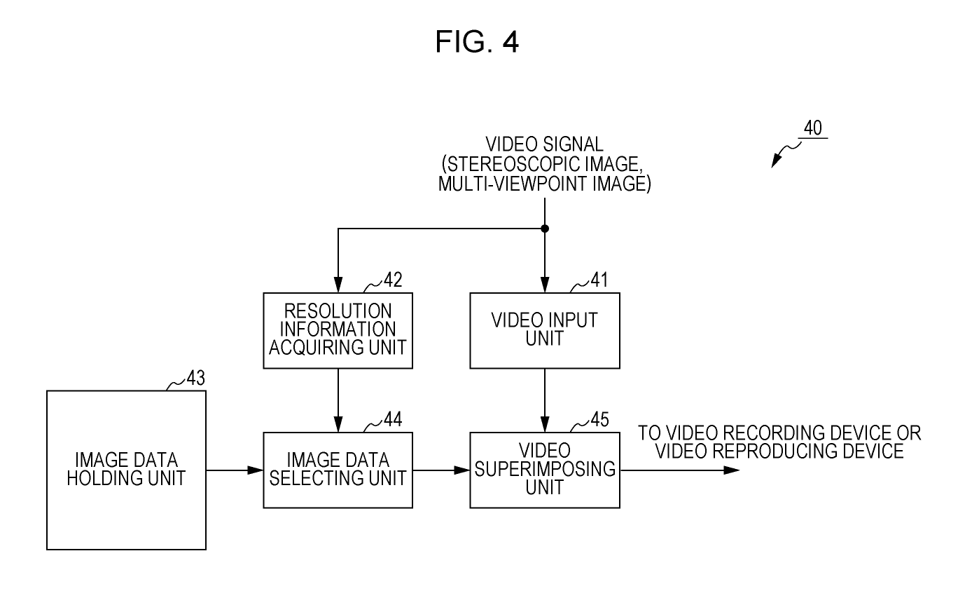

FIG. 4 shows an example of the configuration of a video signal processing apparatus 40 used to process a video signal to be displayed and output on a display device that has a mode in which resolution is reduced in at least a part of a display area. Video signal processing performed by the video signal processing apparatus 40 shown in FIG. 4 can be applied both when a stereoscopic image is recorded and when the recorded stereoscopic image is reproduced.

A video input unit 41 inputs a video signal from an external source. Input video signals may include a video signal for which resolution is reduced in at least a part of a display area, such as a stereoscopic image or a multi-viewpoint image. When a video signal input by the video input unit 41 includes a display area in which resolution is reduced, a resolution information acquiring unit 42 acquires reduced resolution levels 1/n_V and 1/n_H in the vertical and horizontal directions of the display area, together with positional information of the area.

An image data holding unit 43 holds image data, such as character fonts or graphics, to be superimposed on a video signal. The image data holding unit 43 should hold two or more types of image data for each of the same character fonts or graphics; in the image data, for reduced resolution levels 1/n_V and 1/n_H, the width of a horizontal line and the width of a vertical line are broadened to n_V pixels or more and n_H pixels or more, respectively.

An image data selecting unit 44 determines resolution levels 1/n_V and 1/n_H at a position of superimposition of image data, on the basis of information sent from the resolution information acquiring unit 42. For each character font or graphic to be superimposed on the video signal input by the video input unit 41, the image data selecting unit 44 then selects, in response to resolution levels 1/n_V and 1/n_H, image data in which the width of a horizontal line is n_V pixels or more and the width of a vertical line is n_H pixels or more.

Then, a video superimposing unit 45 superimposes the image data selected by the image data selecting unit 44 on the video signal input by the video input unit 41, and outputs the video signal to a video recording device or video reproducing device (both not shown) in a subsequent stage.

It should be understood by those skilled in the art that various modifications, combinations, sub-combinations and alterations may occur depending on design requirements and other factors insofar as they are within the scope of the appended claims or the equivalents thereof.

What is claimed is:

1. A video signal processing apparatus comprising:
a video input unit configured to input a video signal for which resolution is reduced in at least a part of a display area;
an image data changing unit configured to change, in response to the resolution, image data to be superimposed on an area in which the resolution is reduced; and
a video superimposing unit configured to superimpose the image data changed by the image data changing unit on the video signal input by the video input unit.

2. The video signal processing apparatus according to claim 1, wherein the image data changing unit resizes image data so that a horizontal line has a width of n_V pixels or more and a vertical line has a width of n_H pixels or more when the resolution is reduced to 1/n_V and 1/n_H in the vertical and horizontal directions of a screen, respectively.

3. A video signal processing method comprising:
inputting a video signal for which resolution is reduced in at least a part of a display area;
changing, in response to the resolution, image data to be superimposed on an area in which the resolution is reduced; and
superimposing the changed image data on the input video signal.
